(19) United States
(12) Patent Application Publication
(10) Pub. No.: US 2024/0126494 A1
(43) Pub. Date: Apr. 18, 2024

(54) MOBILE VIDEO AND AUDIO BOX CONTROL SYSTEM

(71) Applicant: Shenzhen Metaverse Technology Company Limited, Shenzhen (CN)

(72) Inventors: Xinrong GUAN, Shenzhen (CN); Pei CHEN, Shenzhen (CN)

(21) Appl. No.: 17/983,607

(22) Filed: Nov. 9, 2022

(30) Foreign Application Priority Data
Oct. 18, 2022 (CN) 2022112767767

(51) Int. Cl. G06F 3/14; G09G 5/00

(52) U.S. Cl. CPC G06F 3/14; G09G 5/006; G09G 2370/12

(57) ABSTRACT

A mobile video and audio box control system includes a television (TV) stick, a video splitter, a converter of High Definition Multimedia Interface (HDMI) to DisplayPort (DP), an interface of HDMI to red, green, and blue (RGB), a sub screen, a Micro Control Unit (MCU) circuit, a power management circuit, and a power circuit. The TV stick transmits the video and audio signals to the converter of HDMI to DP and the interface of HDMI to RGB by the video splitter, and the interface of HDMI to RGB transmits the video and audio signals to the sub screen; the MCU circuit is configured to control the interface of HDMI to RGB; the power management circuit is configured to supply power. The system is integrated and stable, and users can watch video and audio contents anytime and anywhere. The system has easy operation, good practicability, and strong battery life.

### TECHNICAL FIELD

The disclosure relates to the technical field of video and audio data control, in particular to a mobile video and audio box control system.

### BACKGROUND

At present, in the prior art, most video and audio contents can only be played by mobile terminals such as mobile phones or portable Android devices (PAD). Augmented Reality/Virtual Reality (AR/VR) glasses are mainly connected with the mobile phone to realize mobile video and audio watching, and various video applications installed in the mobile phone are projected into the AR/VR glasses in a wired mode, so that the mobile video and audio watching is realized.

However, only some mobile phones, such as Huawei Mate series and Samsung flagship mobile phones, support DisplayPort (DP) output through Type-C interfaces. These mobile phones support direct transmission of video and audio contents to the AR/VR glasses in the wired mode, which makes the AR/VR glasses realize the mobile video and audio watching.

Most of the existing mobile phones, such as the iPhone series and Xiaomni® series, do not support wired output of video and audio contents from these phones themselves to the AR/VR glasses for watching the video and audio contents. In addition, a method of using mobile phones to project screens for the AR/VR glasses not only needs to transmit data, but also needs to supply power for the AR/VR glasses, which makes the mobile phones consume a lot of power. Battery life of the mobile phones is easy to make users anxious, and the mobile phones will only make users more anxious about the battery life after projecting screens. In addition, the mobile phones often run out of power without finishing playing a whole movie, which causes obstacles in watching video and audio contents.

From perspective of overseas markets, current mainstream content platforms, such as Asia Television Digital Media Limited (ATV) and Netflix, do not support wired or wireless projection of the mobile phones to other terminals for content copyright protection, including the AR/VR glasses of course.

In order to watch video and audio contents more conveniently and smoothly in the AR/VR glasses and get rid of dependence on the mobile phones, people are eager to develop a new type of video and audio watching control system.

### SUMMARY

In view of this, a purpose of the disclosure is to provide a mobile video and audio box control system which is integrated and stable, and the system ensures that people can watch video and audio contents in AR/VR glasses anytime and anywhere. The system is convenient to be used and has strong practicability and high battery life.

In order to achieve the purpose of disclosure, following technical solutions are used.

A mobile video and audio box control system, includes: a television (TV) stick, a video splitter, a converter of High Definition Multimedia Interface (HDMI) to DisplayPort (DP), an interface of HDMI to red, green, and blue (RGB), a sub screen, a Micro Control Unit (MCU) circuit, a power management circuit, and a power circuit;

the TV stick is configured to transmit video and audio contents; the video splitter is configured to split and convert the video and audio contents; the converter of HDMI to DP is configured to convert video signals into display signals; the interface of HDMI to RGB is configured to convert video and audio signals corresponding to the video and audio contents to RGB signals; the sub screen is configured to display the video and audio contents; the MCU circuit is configured to control and process information; the power management circuit is configured to supply power; and the power circuit is configured to supply power to the power management circuit;

the TV stick is configured to transmit the video and audio signals to the converter of HDMI to DP and the interface of HDMI to RGB by the video splitter, and the interface of HDMI to RGB is configured to transmit the video and audio signals to the sub screen; the MCU circuit is configured to control the interface of HDMI to RGB; the power management circuit is configured to supply power to the TV stick, the video splitter, the converter of HDMI to DP, the interface of HDMI to RGB, the sub screen, and the MCU circuit.

The video splitter includes a low dropout linear regulator, and the low dropout linear regulator is configured to stabilize voltage of signals split and converted by the video splitter.

The power circuit includes a lithium battery.

The power circuit includes a charging circuit, and the charging circuit is configured to charge the power circuit.

The charging circuit includes a charging/discharging interface.

The charging circuit further includes an electric quantity collection circuit, and the electric quantity collection circuit is configured to collect electric quantity information and transmit the collected electric quantity information to the MCU circuit, and the MCU circuit is configured to transmit the collected electric quantity information to the sub screen by the interface of HDMI to RGB.

The MCU circuit includes a scanning key, and the scanning key is configured to control a two-dimensional code.

The MCU circuit further includes a control key, and the control key is configured to start and close the MCU circuit.

The disclosure further includes a key controlling circuit, and the key controlling circuit is configured to control the video and audio contents of the TV stick.

Beneficial effects of the disclosure are: 1) the disclosure transmits video and audio contents to AR/VR glasses by a TV stick, so that users can get rid of the dependence and restriction on mobile phones, and can watch the video and audio contents more conveniently anytime and anywhere; 2) the disclosure provides power for each circuit by a power management circuit, so that the disclosure can watch the video and audio contents for a long time and has a good user experience; 3) the disclosure can control a two-dimensional code by a MCU circuit, which is more convenient to watch the video and audio contents and operate; 4) the disclosure has strong practicability, multiple functions, safety and reliability, simple use, and low cost; and the disclosure is suitable for general promotion.

### BRIEF DESCRIPTION OF DRAWINGS

FIG. 1 is a system block diagram of the mobile video and audio box control system according to an embodiment of the disclosure.

FIG. 2 is another system block diagram of the mobile video and audio box control system according to an embodiment of the disclosure.

### DETAILED DESCRIPTION OF EMBODIMENTS

The technical solutions in the embodiments of the disclosure will be described clearly and completely below in combination with the drawings in the embodiments of the disclosure. Apparently, the described embodiments are only some embodiments of the disclosure, not all of them. Based on the embodiments of the disclosure, all other embodiments obtained by those skilled in the art without creative work belong to the scope of the disclosure.

It should be noted that all directional indications (such as up, down, left, right, front, back, etc.) in the embodiments of the disclosure are only used to explain the relative position relationship, motion, etc. of components in a specific attitude (as shown in the figures). If the specific attitude changes, the directional indication will change accordingly.

In the disclosure, unless otherwise specified and defined, the terms “connection”, “fixation”, etc. should be understood openly. For example, “fixation” can be a fixed connection, a detachable connection, or integrated to a whole; it can be mechanical connection or electrical connection; it can be directly connected or indirectly connected through an intermediate medium; it can be the connection between two elements or the interaction between two elements, unless otherwise specified. For those skilled in the art, the specific meaning of the above terms in the disclosure can be understood according to specific situations.

In addition, descriptions of “first”, “second” and the like in the disclosure are only for the purpose of description, and these descriptions cannot be understood as indicating or implying their relative importance or implying the number of indicated technical features. Thus, the features defined as “first” and “second” can explicitly or implicitly include at least one such feature. In addition, the technical solutions of various embodiments can be combined with each other, but they must be based on the realization by those skilled in the art. When the combination of technical solutions is contradictory or impossible, it should be considered that the combination of such technical solutions does not exist and is not within the scope of protection claimed by the disclosure.

The disclosure is further described in detail below in combination with the accompanying drawings and embodiments of the disclosure.

### Embodiment 1

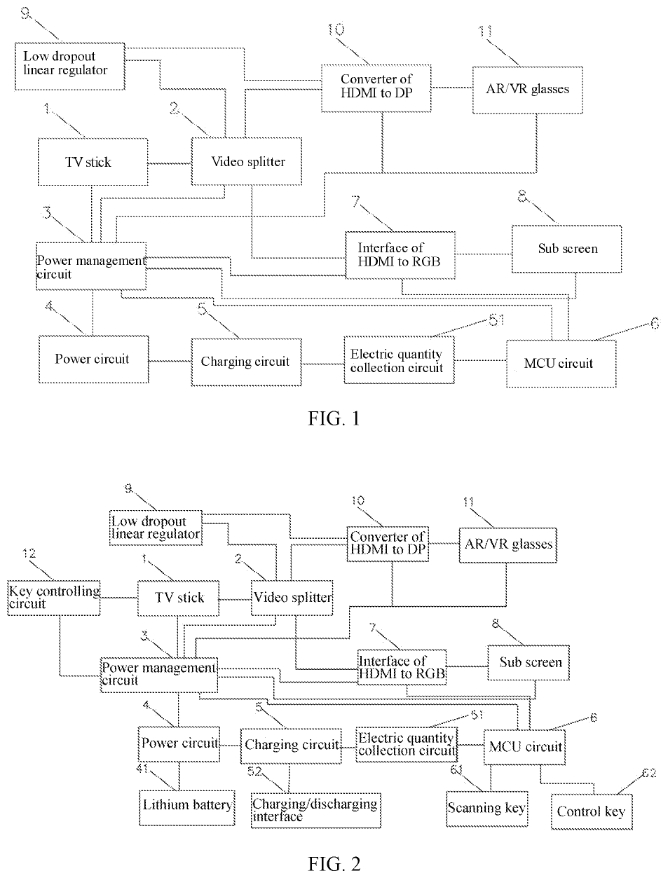

As shown in FIG. 1, a mobile video and audio box control system includes a TV stick 1, a video splitter 2, a converter of HDMI to DP 10, an interface of HDMI to RGB 7, a sub screen 8, a MCU circuit 6, a power management circuit 3, and a power circuit 4.

The TV stick 1 is configured to transmit video and audio contents; the video splitter 2 is configured to split and convert the video and audio contents; the converter of HDMI to DP 10 is configured to convert video signals into display signals; the interface of HDMI to RGB 7 is configured to convert video and audio signals corresponding to the video and audio contents to RGB signals; the sub screen 8 is configured to display the video and audio contents; the MCU circuit 6 is configured to control and process information; the power management circuit 3 is configured to supply power; and the power circuit 4 is configured to supply power to the power management circuit 3.

The TV stick 1 is configured to transmit the video and audio signals to the converter of HDMI to DP 10 and the interface of HDMI to RGB 7 by the video splitter 2, and the interface of HDMI to RGB 7 is configured to transmit the video and audio signals to the sub screen 8; the MCU circuit 6 is configured to control the interface of HDMI to RGB 7; the power management circuit 3 is configured to supply power to the TV stick 1, the video splitter 2, the converter of HDMI to DP 10, the interface of HDMI to RGB 7, the sub screen 8, and the MCU circuit 6.

In the embodiment, the TV stick 1 of the disclosure is a memory with video website links. Many websites at home and abroad provide regular TV programs. The memory gathers videos from various TV stations, and the TV stick is equivalent to an online video collector.

In the embodiment, the TV stick 1 is configured to transmit the video and audio signals to the converter of HDMI to DP 10 by the video splitter 2, and the converter of HDMI to DP 10 is configured to transmit the video and audio contents of the TV stick 1 to an AR/VR glasses 11. Therefore, people are easy to watch the video and audio contents by wearing the AR/VR glasses 11.

In the embodiment, the video and audio contents obtained by the TV stick 1 include a two-dimensional code. Since the two-dimensional code is displayed on a TV screen in the prior art, a user can scan the code once taking out his mobile phone. However, it is almost impossible to take out the mobile phone to scan the code in AR/VR glasses 11 while watching the video and audio contents by the AR/VR glasses 11.

Therefore, the disclosure can not only display the video and audio contents but also display the two-dimensional code in the video and audio contents by the sub screen 8. When the two-dimensional code is displayed in the sub screen 8, the user can scan the two-dimensional code in the sub screen 8 by the mobile phone. After scanning, the user can continue to watch the video and audio contents.

In the embodiment, in order to control the TV stick 1 to transmit the video and audio contents to the sub screen 8 by the video splitter 2, the disclosure controls the interface of HDMI to RGB 7 by the MCU circuit 6 to realize the transmission of the video and audio contents to the sub screen 8. When the user does not want to transmit the video and audio contents to the sub screen 8, the MCU circuit 6 disconnects the transmission of the video and audio contents by controlling the interface of HDMI to RGB 7, and therefore the video and audio contents cannot be transmitted to the sub screen 8.

In the embodiment, preferably, the MCU circuit 6 includes a chip with a model of STM32F103.

As shown in FIG. 2, in the embodiment, preferably, the MCU circuit 6 includes a scanning key 61, and the scanning key 61 is configured to control a two-dimensional code.

The scanning key 61 controls the two-dimensional code on the sub screen 8 by the MCU circuit 6, and the user can scan the two-dimensional code on the sub screen 8, which is more convenient to use and watch the video and audio contents.

In the embodiment, when the user watches the video and audio contents by the AR/VR glasses 11, the two-dimensional code will pop up in the use scenarios such as login and payment. The two-dimensional code seen by the AR/VR glasses 11 can be copied to the sub screen 8 by the scanning key 61, and therefore the user can take out his mobile phone to scan the two-dimensional code.

As shown in FIG. 2, in the embodiment, preferably, the MCU circuit 6 further includes a control key 62, and the control key 62 is configured to start and close the MCU circuit 6.

In the embodiment, the control key 62 is configured to start and close the MCU circuit 6, which makes the operation more flexible and convenient.

In the embodiment, preferably, the video splitter 2 includes a low dropout linear regulator 9, and the low dropout linear regulator 9 is configured to stabilize voltage of signals split and converted by the video splitter 2.

Preferably, the low dropout linear regulator 9 is also configured to stabilize voltage of signals converted by the converter of HDMI to DP 10.

In the embodiment, corresponding video and audio contents can be displayed on the AR/VR glasses 11 and the sub screen 8 at the same time after the video splitter 2 splits the video and audio signals.

As shown in FIG. 1 and FIG. 2, in the embodiment, preferably, the power circuit 4 includes a lithium battery 41. The disclosure can integrate a battery, a video and audio signal source (i.e., the TV stick), a signal converter and other circuits into an integrated product, and therefore the product is mobile.

In the embodiment, preferably, the power circuit 4 includes a charging circuit 5, and the charging circuit 5 is configured to charge the power circuit 4.

The charging circuit 5 charges the power circuit 4 and the power circuit 4 can provide power for the power management circuit 3 for a long time, and the power management circuit 3 charges each circuit of the disclosure, which ensures that the user can watch the video and audio contents by the AR/VR glasses 11 for a long time, and watching the video and audio contents is more convenient and enjoyable.

In the embodiment, preferably, the charging circuit 5 includes a charging/discharging interface 52. The charging/discharging interface 52 is also configured to supply power for external devices such as mobile phones.

The charging/discharging interface 52 is also configured to connect with an external charging device to charge the power circuit 4 by the charging circuit 5, which further ensures the stability of the power supply.

In the embodiment, preferably, the charging circuit 5 further includes an electric quantity collection circuit 51, and the electric quantity collection circuit 51 is configured to collect electric quantity information and transmit the collected electric quantity information to the MCU circuit 6, and the MCU circuit 6 is configured to transmit the electric quantity information to the sub screen 8 by the interface of HDMI to RGB 7.

In the embodiment, the MCU circuit 6 is configured to transmit the electric quantity information to the sub screen 8, the user can see the electric quantity information on the sub screen 8; the user can charge once the user see the electric quantity is low, which ensures the user can watch the video and audio contents by the AR/VR glasses 11 continuously.

In the embodiment, preferably, the disclosure further includes a key controlling circuit 12, and the key controlling circuit 12 is configured to control the video and audio contents of the TV stick 1 and provide a user interaction function.

In the embodiment, watching the video and audio contents is more convenient by the key controlling circuit 12 which is configured to control the video and audio contents of the TV stick 1.

In the embodiment, preferably, the key controlling circuit 12 can be integrated in the system of the disclosure, so that the key control circuit 12 can become a controller, and it is more convenient to transmit the video and audio contents and watch the video and audio contents.

In the embodiment, preferably, the scanning key 61 of the disclosure can be merged in the control key 62, which realizes that the disclosure can automatically copy the video and audio contents of the AR/VR glasses 11 and switch, display, and close the contents of the sub screen 8 by a single click.

The disclosure creates a new use scenario for users, which brings the users a new experience of mobile video and audio watching. The disclosure can also integrate multiple devices into a new intelligent terminal, which is more economical, more efficient, more convenient, and has strong universality. The disclosure can be reused by AR/VR and other head-worn audio and video devices. The disclosure can also carry out modular designs, which reduces the cost and is suitable for general promotion.

The above descriptions are only some embodiments of the disclosure and are not intended to limit the protection scope of the disclosure.

What is claimed is:

1. A mobile video and audio box control system, comprising: a television (TV) stick, a video splitter, a converter of High Definition Multimedia Interface (HDMI) to DisplayPort (DP), an interface of HDMI to red, green, and blue (RGB), a sub screen, a Micro Control Unit (MCU) circuit, a power management circuit, and a power circuit;
wherein the TV stick is configured to transmit video and audio contents; the video splitter is configured to split and convert the video and audio contents; the converter of HDMI to DP is configured to convert video signals into display signals; the interface of HDMI to RGB is configured to convert video and audio signals corresponding to the video and audio contents to RGB signals; the sub screen is configured to display the video and audio contents; the MCU circuit is configured to control and process information; the power management circuit is configured to supply power; and the power circuit is configured to supply power to the power management circuit;
wherein the TV stick is configured to transmit the video and audio signals to the converter of HDMI to DP and the interface of HDMI to RGB by the video splitter, and the interface of HDMI to RGB is configured to transmit the video and audio signals to the sub screen; the MCU circuit is configured to control the interface of HDMI to RGB; the power management circuit is configured to supply power to the TV stick, the video splitter, the converter of HDMI to DP, the interface of HDMI to RGB, the sub screen, and the MCU circuit.

2. The mobile video and audio box control system according to claim 1, wherein the video splitter comprises a low dropout linear regulator, and the low dropout linear regulator is configured to stabilize voltage of signals split and converted by the video splitter.

3. The mobile video and audio box control system according to claim 2, wherein the power circuit comprises a lithium battery.

4. The mobile video and audio box control system according to claim 3, wherein the power circuit comprises a charging circuit, and the charging circuit is configured to charge the power circuit.

5. The mobile video and audio box control system according to claim 4, wherein the charging circuit comprises a charging/discharging interface.

6. The mobile video and audio box control system according to claim 5, wherein the charging circuit further comprises an electric quantity collection circuit, and the electric quantity collection circuit is configured to collect electric quantity information and transmit the collected electric quantity information to the MCU circuit, and the MCU circuit is configured to transmit the collected electric quantity information to the sub screen by the interface of HDMI to RGB.

7. The mobile video and audio box control system according to claim 6, wherein the MCU circuit comprises a scanning key, and the scanning key is configured to control a two-dimensional code.

8. The mobile video and audio box control system according to claim 7, wherein the MCU circuit further comprises a control key, and the control key is configured to start and close the MCU circuit.

9. The mobile video and audio box control system according to claim 8, wherein the mobile video and audio box control system further comprises a key controlling circuit, and the key controlling circuit is configured to control the video and audio contents of the TV stick.
